(19) United States
(12) Patent Application Publication
(10) Pub. No.: US 2012/0089799 A1
(43) Pub. Date: Apr. 12, 2012

(54) DATA BACKUP PROCESSING METHOD, DATA STORAGE NODE APPARATUS AND DATA STORAGE DEVICE

(75) Inventor: Mingchang WEI, Chengdu (CN)

(73) Assignee: CHENGDU HUAWEI SYMANTEC TECHNOLOGIES CO., LTD., Chengdu (CN)

(21) Appl. No.: 13/324,629

(22) Filed: Dec. 13, 2011

Related U.S. Application Data
(63) Continuation of application No. PCT/CN2010/073994, filed on Jun. 17, 2010.

(30) Foreign Application Priority Data
Jun. 18, 2009 (CN) 200910142492.7

(51) Int. Cl. G06F 12/16

(52) U.S. Cl. 711/162; 711/E12.103

(57) ABSTRACT

A data backup processing method is provided, which includes: numbering at least one data storage node in a data storage device, in which the data storage node includes a primary storage area and a backup storage area, and the primary storage area of the data storage node and a backup storage area of a next adjacently numbered data storage node are logically connected, so that a number of data storage nodes form a ring structure with sequential logical connection; and respectively backing up the data stored in a primary storage area of a random data storage node into a backup storage area of at least one next adjacently numbered data storage node of the data storage node in the ring structure. Therefore, data redundancy may be provided for users among a random number of disks, thereby effectively guaranteeing the security of user data and achieving high flexibility and practicability.

### CROSS-REFERENCE TO RELATED APPLICATIONS

This application is a continuation of International Application No. PCT/CN2010/073994, filed on Jun. 17, 2010, which claims priority to Chinese Patent Application No. 200910142492.7, filed on Jun. 18, 2009, both of which are hereby incorporated by reference in their entireties.

### FIELD OF THE INVENTION

The present invention relates to the field of communications technologies, and in particular, to a data backup processing method, a data storage node apparatus and a data storage device.

### BACKGROUND OF THE INVENTION

With the development of information technologies, information security becomes more and more important and users have increasingly higher performance requirements for disk storage systems. To acquire a disk storage system with a larger capacity, a higher speed and higher reliability and applicability, generally a Redundant Arrays of Inexpensive Disks (RAID) technology is adopted in the existing solutions.

An existing storage system includes a number of storage nodes. Each storage node consists of disk arrays formed of several disks. A number of RAID types may be provided according to the requirements of users, for example, to increase a storage capacity or to provide data redundancy to guarantee the security of user data. In the existing RAID technology, only the RAID0 technology is used for increasing the capacity only without providing data redundancy. The data is lost when any disk is damaged. In several other RAID types such as RAID1, RAID5, RAID6 and RAID10, the data redundancy is provided to guarantee the security of user data. Each RAID type that provides the data redundancy corresponds to a certain number of disks. For example, RAID1 has to require an even number of disks in a corresponding disk array. When data needs to be written, the system performs redundancy storage in the disk array according to the RAID type of the disk array in the node for data to be stored in each storage node. When a failure occurs on one disk in the disk array, the system performs automatic search and determines the data stored in the failure disk to guarantee the data security, therefore becoming rather popular among the users.

During the implementation of the present invention, the inventor finds that the prior art at least has the following problem. In an existing storage system with data redundancy, a fixed number of disks are required in a corresponding disk array no matter which type of RAID technology is adopted, which is inconvenient for use.

### SUMMARY OF THE INVENTION

Embodiments of the present invention provide a data backup processing method, a data storage node apparatus and a data storage device, so as to provide data redundancy for a user among a random number of disks.

An embodiment of the present invention provides a data backup processing method, which includes:

numbering N disks within a data storage node, so that the N disks form a ring structure with sequential logical connection according to respective corresponding numbers thereof; and

respectively storing first data and M pieces of data corresponding to the first data in (M+1) disks logically connected to each other in the ring structure, in which the (M+1) disks form one disk group, N and M are both positive integers, and N≧M+1.

An embodiment of the present invention further provides a data backup processing method, which includes:

numbering at least one data storage node in a data storage device, in which the data storage node includes a primary storage area and a backup storage area, and the primary storage area of the data storage node and a backup storage area of a next adjacently numbered data storage node are logically connected, so that a number of data storage nodes form a ring structure with sequential logical connection; and

respectively backing up the data stored in a primary storage area of a random data storage node into a backup storage area of at least one next adjacently numbered data storage node of the data storage node in the ring structure.

An embodiment of the present invention provides a data storage node apparatus, which includes:

a first processing module, configured to number N disks within a data storage node, so that the N disks form a ring structure with sequential logical connection according to respective corresponding numbers thereof; and

a second processing module, configured to respectively store first data and M pieces of data corresponding to the first data in (M+1) disks logically connected to each other in the ring structure, in which the (M+1) disks form one disk group, N and M are both positive integers, and N≧M+1.

An embodiment of the present invention further provides a data storage device, which includes:

a fifth processing module, configured to number at least one data storage node in a data storage device, in which the data storage node includes a primary storage area and a backup storage area, and the primary storage area of the data storage node and a backup storage area of a next adjacently numbered data storage node are logically connected, so that a number of data storage nodes form a ring structure with sequential logical connection; and

a sixth processing module, configured to respectively back up the data stored in a primary storage area of a random data storage node into a backup storage area of at least one next adjacently numbered data storage node of the data storage node in the ring structure.

The data backup processing method, the data storage node apparatus and the data storage device provided in the embodiments of the present invention are capable of providing data redundancy processing for users among a random number of disks, thereby effectively guaranteeing the security of user data and achieving high flexibility and practicability.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a flow chart of a data backup processing method according to Embodiment 1 of the present invention;

FIG. 2 is a first exemplary diagram of a data storage node according to an embodiment of the present invention;

FIG. 3 is a partial flow chart of a data backup processing method according to Embodiment 2 of the present invention;

FIG. 4 is a second exemplary diagram of a data storage node according to an embodiment of the present invention;

FIG. 5 is a partial flow chart of a data backup processing method according to Embodiment 3 of the present invention;

FIG. 6 is a third exemplary diagram of a data storage node according to an embodiment of the present invention;

FIG. 7 is a flow chart of a data backup processing method according to Embodiment 4 of the present invention;

FIG. 8 is a fourth exemplary diagram of a data storage device according to an embodiment of the present invention;

FIG. 9 is a partial flow chart of a data backup processing method according to Embodiment 5 of the present invention;

FIG. 10 is a fifth exemplary diagram of a data storage device according to an embodiment of the present invention;

FIG. 11 is a partial flow chart of a data backup processing method according to Embodiment 6 of the present invention;

FIG. 12 is a structure diagram of a data storage node apparatus according to Embodiment 7 of the present invention;

FIG. 13 is a structure diagram of a data storage node apparatus according to Embodiment 8 of the present invention;

FIG. 14 is a structure diagram of a data storage node apparatus according to Embodiment 9 of the present invention;

FIG. 15 is a structure diagram of another data storage node apparatus according to Embodiment 9 of the present invention;

FIG. 16 is a structure diagram of a data storage device according to Embodiment 10 of the present invention;

FIG. 17 is a structure diagram of a data storage device according to Embodiment 11 of the present invention;

FIG. 18 is a structure diagram of a data storage device according to Embodiment 12 of the present invention; and

FIG. 19 is a structure diagram of another data storage device according to Embodiment 12 of the present invention.

### DETAILED DESCRIPTION OF THE EMBODIMENTS

The technical solutions of the present invention will be clearly and completely described in the following with reference to the accompanying drawings. It is obvious that the embodiments to be described are only a part rather than all of the embodiments of the present invention. All other embodiments obtained by persons of ordinary skill in the art based on the embodiments of the present invention without creative efforts shall fall within the protection scope of the present invention.

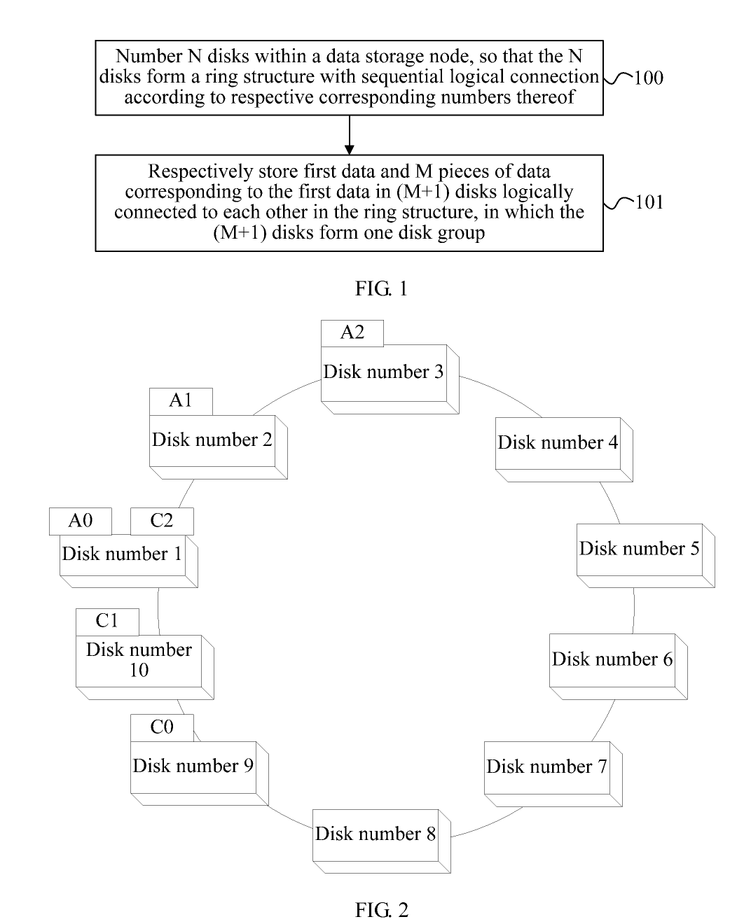

Embodiment 1 of the present invention provides a data backup processing method for providing data redundancy for users among a random number of disks to guarantee the security of user data in a storage device. FIG. 1 is a flow chart of a data backup processing method according to Embodiment 1 of the present invention. The data backup processing method specifically includes the following steps.

Step 100: Number N disks within a data storage node, so that the N disks form a ring structure with sequential logical connection according to respective corresponding numbers thereof.

Step 101: Respectively store first data and M pieces of data corresponding to the first data in (M+1) disks logically connected to each other in the ring structure, in which the (M+1) disks form one disk group, N and M are both positive integers, and N≧M+1.

Specifically, the data backup processing method of this embodiment is mainly a method of backup processing for data within a data storage node. The N disks in the data storage node are numbered, for example, a disk number 1, a disk number 2, a disk number 3, . . . , and a disk number N. The N disks are then logically connected in sequence according to respective corresponding numbers thereof. That is, the disk number 1 is connected to the disk number 2. The disk number 2 is subsequently connected to the disk number 3, and so on. The disk number N is connected to the disk number 1. Therefore, the N disks form a ring structure with sequential logical connection.

The first data in the embodiment of the present invention is raw data. The M pieces of data corresponding to the first data are respectively backup data of the raw data. The first data may further be check fragment data of M pieces of fragmented data of the raw data. At this time, the M pieces of data corresponding to the first data are the M pieces of fragmented data of the raw data. The check fragment data of the M pieces of fragmented data here is acquired through Exclusive-OR (XOR) processing or processing with error detection and correction algorithm on the M pieces of fragmented data.

In the following, the first case, that is, the first data is the raw data and the M pieces of data corresponding to the first data are respectively the backup data of the raw data, is taken as an example to illustrate the technical solution of this embodiment in detail.

M pieces of backup data are made from the raw data. Then, the raw data and the M pieces of backup data of the raw data are respectively stored in the disk group formed of the (M+1) disks logically connected to each other in the ring structure. That is, it should be ensured that the raw data and the M pieces of backup data of the raw data are respectively stored in the logically connected (M+1) disks among the N disks in the ring structure. The specific backup implementing manner may be backup clockwise or counterclockwise, and may also include a specifically adopted backup solution, for example, an arrangement relationship between backup data storage disks and raw data storage disks. FIG. 2 is a first exemplary diagram of a data storage node according to an embodiment of the present invention. As shown in FIG. 2, an example in which the data storage node includes 10 disks and 2 backups are made from the raw data is taken to illustrate the technical solution of Embodiment 1 of the present invention in detail. First, 10 disks are numbered and the 10 disks then form a logically connected ring structure according to the numbers. Next, the raw data and the 2 backups of the raw data are respectively stored clockwise in a disk group formed of 3 disks logically connected to each other in the 10 disks. As shown in FIG. 2, the raw data C0 is stored in the disk number 9. The backup data C1 and the backup data C2 of the raw data C0 are respectively stored in the disk number 10 and the disk number 1. Therefore, the disk number 9, the disk number 10 and the disk number 1 form a disk group for storing the data C. The raw data A0 is stored in the disk number 1. The backup data A1 and the backup data A2 of the raw data A0 are respectively stored in the disk number 2 and the disk number 3. Therefore, the disk number 1, the disk number 2 and the disk number 3 also form a disk group for storing the data A. In the example, the disks for storing the backup data are among disks next to the disk storing the raw data. In practical operation, in one disk group, the disks for storing the backup data may be located previous to or next to the disk storing the raw data or arranged at two sides of the disk storing the raw data. As the backup data and the raw data are the same, it only needs to ensure that the raw data and the M pieces of backup data of the raw data are respectively stored in the disk group formed of the (M+1) disks logically connected to each other.

In the second case, when the first data is the check fragment data of the M pieces of fragmented data of the raw data, the M pieces of data corresponding to the first data are the M pieces of fragmented data of the raw data. That is, each of the M pieces of data corresponding to the first data corresponds to one of the M pieces of fragmented data of the raw data. At this time, different from the corresponding data backup processing method in which the first data is the raw data and the M pieces of data corresponding to the first data are respectively the backup data of the raw data, here the raw data is divided into M fragments. The check fragment data of the M pieces of fragmented data of the raw data serves as the first data. Therefore, the M pieces of data corresponding to the first data are the M pieces of fragmented data of the raw data. The M pieces of fragmented data of the raw data and the check fragment data of the M pieces of fragmented data are respectively stored in the disk group formed of the (M+1) disks logically connected to each other in the data storage node. The rest are the same as those in the corresponding data backup processing method in which the first data is the raw data and the M pieces of data corresponding to the first data are respectively the backup data of the raw data, the details of which are no longer described herein.

The data backup processing method provided in this embodiment implements redundancy backup of the stored data in the logically connected disks in the ring structure, and may provide data redundancy for users among a random number of disks. In the method of this embodiment, the raw data and a number of backups thereof are respectively stored in the logically connected disks in the ring structure. The pieces of fragmented data of the raw data and the check fragment data formed of all the fragmented data may also be respectively stored in the logically connected disks in the ring structure. As the probability that failures occur on continuous disks is relatively small, the data backup processing method of this embodiment may effectively reduce the risk of loss of the stored data and improve the security of user data.

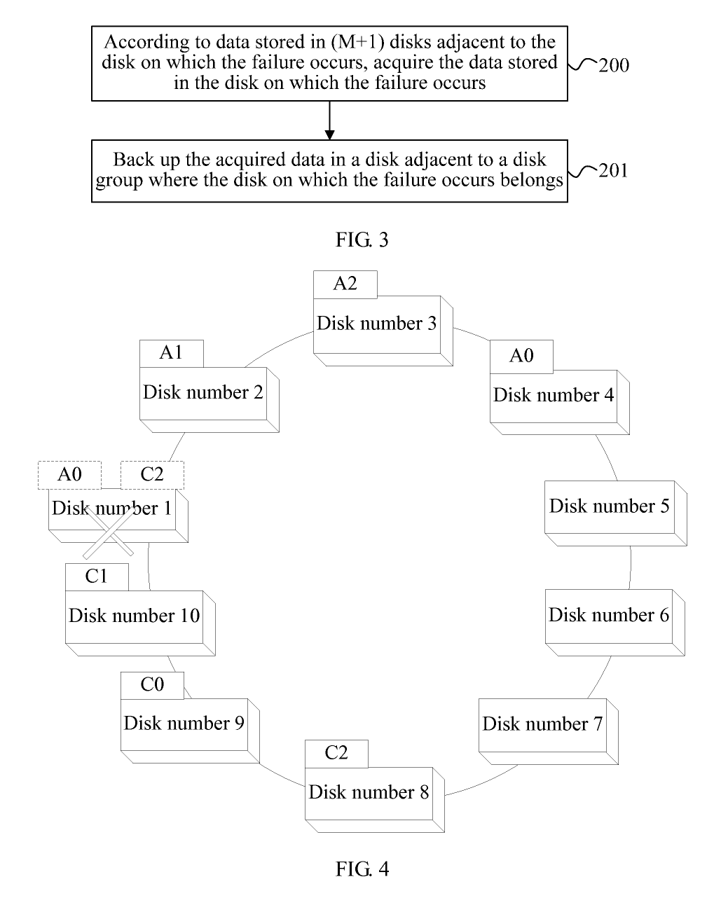

FIG. 3 is a partial flow chart of a data backup processing method according to Embodiment 2 of the present invention. When a failure occurs on one disk in the ring structure in Embodiment 1, the data backup processing method in Embodiment 2 of the present invention further includes steps in FIG. 3 on the basis of Embodiment 1, which are specifically as follows.

Step 200: Acquire the data stored in the disk on which the failure occurs according to data stored in (M+1) disks adjacent to the disk on which the failure occurs.

Step 201: Back up the acquired data into a disk adjacent to a disk group where the disk on which the failure occurs belongs.

In the first case, when the first data is the raw data and the M pieces of data corresponding to the first data are respectively the backup data of the raw data, the data backup processing method when a failure occurs on one disk in the ring structure is as follows.

Specifically, if a failure occurs on one disk in the ring structure, the disk on which the failure occurs exits the ring structure. The data stored in the disk on which the failure occurs is lost. The lost data in the disk on which the failure occurs usually includes raw data and backup data, and certainly may include raw data or backup data only. According to the data stored in the previous adjacent (M+1) disks and the next adjacent (M+1) disks of the disk on which the failure occurs, the lost data stored in the disk on which the failure occurs may be determined. Next, the backup data corresponding to the raw data in the lost data is backed up into a disk adjacent to a disk group storing the raw data to compensate the lost raw data. Therefore, the disk storing the backup data of the raw data requires no backup or update to conveniently form a new disk group storing the raw data and the backup data thereof in the lost data. Certainly, the backup data of the raw data in the lost data may also be backed up into any other normally working disk. At this time, the M pieces of backup data of the raw data need to be respectively cut into M disks adjacent to the normally working disk to ensure that the disk storing the raw data and the M disks storing the backup data of the raw data are located in a disk group formed of (M+1) disks logically connected to each other. In the embodiment of the present invention, the cut is to remove the corresponding data in the original disk and make backup in the new disk for storage. That is to say, the corresponding data in the original disk is migrated onto a new disk and the corresponding data in the original disk is deleted. Similarly, the raw data corresponding to the backup data in the lost data is backed up into one disk adjacent to the disk group in which the backup data and the raw data thereof are located, so as to ensure that the disk storing the backup data, the other (M−1) disks respectively storing data the same as the backup data, and the disk storing the raw data corresponding to the backup data are in a disk group formed of the (M+1) disks logically connected to each other.

FIG. 4 is a second exemplary diagram of a data storage node according to an embodiment of the present invention. In the exemplary diagram, an example in which the data storage node includes 10 disks and 2 backups are made from the raw data is taken to illustrate the technical solution of Embodiment 2 of the present invention in detail. As shown in FIG. 4, when a failure occurs on the disk number 1, the disk number 1 exits the ring structure, and the data stored in the disk number 1 is lost. The raw data and the backup data of the raw data are stored in a disk group formed of 3 disks logically connected to each other. According to the data stored in 3 disks next to the disk number 1, that is, the disk number 2, the disk number 3 and the disk number 4, as the backup data A1 and A2 of A0 are stored in the disk number 2 and the disk number 3 while the raw data A0 is not stored in the disk number 4, it can be determined that the raw data A0 is stored in the disk number 1. The backup data of the raw data A0 in the lost data is backed up into the disk number 10 or the disk number 4 (in FIG. 4, the example taken is that the backup data is backed up into the disk number 4) as the raw data A0. Therefore, the disk storing the raw data A0 and the disks storing the backup data of the raw data A0 conveniently form a new disk group again (that is, a new disk group formed of the disk number 2, the disk number 3 and the disk number 4). Certainly, the backup data A1 or A2 of the raw data A0 in the lost data is backed up into any normally working disk, for example, backed up into the disk number 7. At this time, the 2 pieces of backup data of the raw data A0 need to be cut into 2 disks adjacent to the disk number 7 (that is, cut into the disk number 8 and the disk number 9, or cut into the disk number 5 and the disk number 6, or cut into the disk number 6 and the disk number 8), so as to ensure that the disk storing the raw data and the disks storing the 2 pieces of backup data of the raw data are in the disk group formed of 3 disks logically connected to each other. Similarly, according to the data stored in 3 disks previous to the disk number 1, that is, the disk number 8, the disk number 9 and the disk number 10, as the raw data C0 or the backup data of the raw data C0 is not stored in the disk number 8, it may be determined that one piece of backup data of the raw data C0 is stored in the disk number 1. The raw data C0 corresponding to the backup data in the lost data is backed up into the disk number 8 or the disk number 2 (in FIG. 4, the taken example is that the raw data C0 is backed up into the disk number 8). Therefore, it is ensured that the disk storing the raw data C0 and the disks storing the backup data of the raw data C0 are still in a disk group formed of 3 disks logically connected to each other.

In the second case, when the first data is the check fragment data of the M pieces of fragmented data of the raw data and the M pieces of data corresponding to the first data are the M pieces of fragmented data of the raw data, the data backup processing method when a failure occurs on one disk in the ring structure is as follows.

Specifically, if a failure occurs on one disk in the ring structure, the disk on which the failure occurs exits the ring structure, and one piece of the fragmented data of the raw data or the check fragment data of the M pieces of fragmented data stored in the disk on which the failure occurs is lost. According to the data stored in the previous adjacent (M+1) disks and the next adjacent (M+1) disks of the disk on which the failure occurs, the lost data stored in the disk on which the failure occurs may be acquired. Specifically, two following cases exist. When the lost data is one of the M pieces of fragmented data, inverse XOR processing or inverse processing with error detection and correction algorithm is performed on both the rest (M−1) pieces of fragmented data and the check fragment data to acquire the lost data. When the lost data is the check fragment data, the XOR processing or processing with error detection and correction algorithm is performed on the M pieces of fragmented data to acquire the check fragment data.

Next, the acquired data is backed up into one disk adjacent to the disk group where the raw data is located. Therefore, the disk where the lost fragmented data is stored and the disks storing the other (M−1) pieces of fragmented data of the raw data may conveniently form a new disk group. Certainly, the lost fragmented data may also be backed up into any other normally working disk. At this time, the other (M−1) pieces of fragmented data of the raw data and the check fragment data of the M pieces of fragmented data are respectively cut into M disks adjacent to the normally working disk where the lost data is backed up. However, it has to ensure that the disk where the M pieces of fragmented data of the raw data are respectively stored and the disk where the check fragment data of the M pieces of fragmented data is stored are in a disk group formed of (M+1) disks logically connected to each other.

In the data backup processing method of this embodiment, data redundancy may be provided for users among a random number of disks. When a failure occurs on one disk in the ring structure, the data stored in the disk on which the failure occurs may be determined, and the lost data may be backed up in another disk again. When the method of this embodiment is adopted to store data, when a failure occurs on one disk, the effective operation of the storage system may still be ensured without changing the disk right away, so that the security of user data is improved, the risk of loss of the stored data is effectively reduced, and high practicability is achieved.

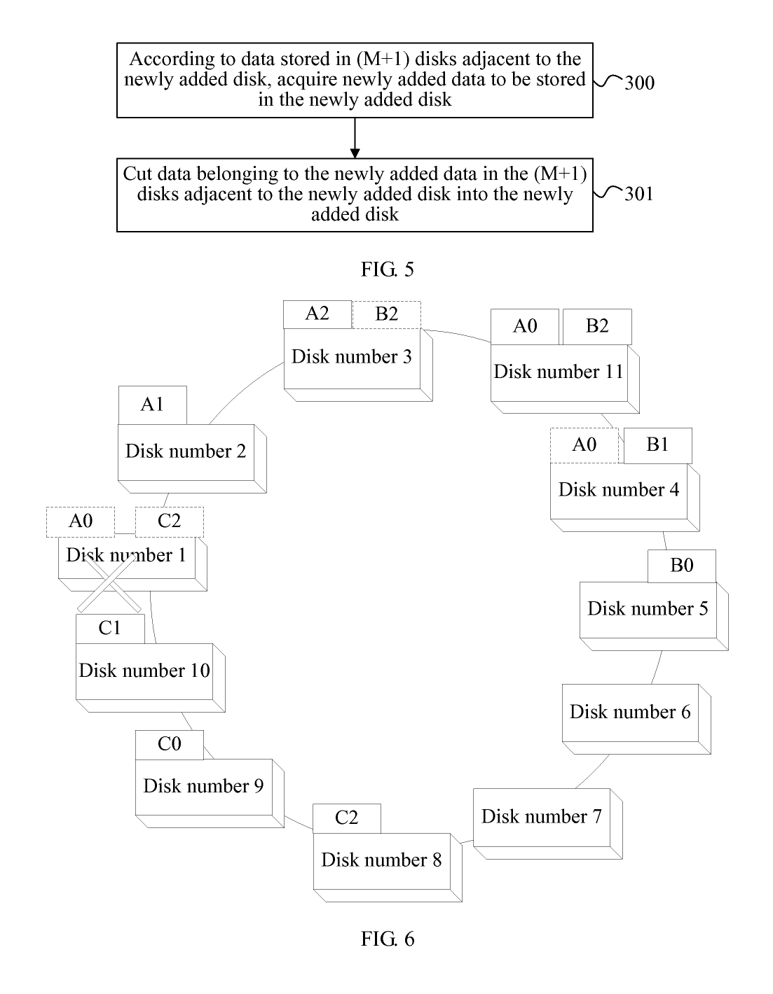

FIG. 5 is a partial flow chart of a data backup processing method according to Embodiment 3 of the present invention. When one disk is added in the ring structure in Embodiment 1, the data backup processing method in Embodiment 3 of the present invention further includes steps shown in FIG. 5 on the basis of Embodiment 1 or Embodiment 2 of the present invention, which are specifically as follows.

Step 300: According to data stored in (M+1) disks adjacent to the newly added disk, acquire newly added data to be stored in the newly added disk.

Step 301: Cut data belonging to the newly added data in the (M+1) disks adjacent to the newly added disk into the newly added disk.

In the first case, when the first data is the raw data and the M pieces of data corresponding to the first data are respectively the backup data of the raw data, the data backup processing method when one disk is added in the ring structure is as follows.

Specifically, when one disk is added in the ring structure, according to the data stored in the (M+1) disk adjacent to the newly added disk, the newly added data to be stored in the newly added disk is determined. Here, it is considered that one disk group is formed of (M+1) disks logically connected to each other. When one disk is newly added, a certain disk group may be interrupted. Therefore, the newly added data to be stored in the newly added disk can only be determined by taking full consideration of the data stored in the previous (M+1) adjacent disks and the next (M+1) adjacent disks of the newly added disk. Next, the newly added data is cut into the newly added disk. Therefore, it is ensured that the disk storing the raw data and the M disks respectively storing the backup data of the raw data are in a disk group formed of (M+1) disks logically connected to each other.

FIG. 6 is a third exemplary diagram of a data storage node according to an embodiment of the present invention. The exemplary diagram is on the basis of the exemplary diagram shown in FIG. 4. At this time, the disk number 1 on which a failure occurs exits the ring structure. Next, one disk is added in the ring structure in the storage node. Here, one disk number 11 is added between the disk number 3 and the disk number 4. At this time, the newly added disk interrupts the logically connected disk group formed by the disk number 4 storing the raw data A0 and the disk number 2 and the disk number 3 storing the backup data of the raw data A0. According to the previous 3 adjacent disks (that is, the disk number 10, the disk number 2 and the disk number 3) of the newly added disk (that is, the disk number 11), and the next 3 adjacent disks (that is, the disk number 4, the disk number 5 and the disk number 6) of the newly added disk (that is, the disk number 11), it may be determined that the raw data A0 stored in the disk number 4 needs to be cut into the newly added disk number 11 as the newly added data. If at this time, the raw data B0 is stored in the disk number 5 and the backup data B1 and the backup data B2 of the raw data B0 are respectively stored in the disk number 4 and the disk number 3, when the disk number 11 is added between the disk number 3 and the disk number 4, the logically connected disk group formed of the disk number 5 storing the raw data B0 and the disk number 4 and the disk number 3 storing the backup data B1 and the backup data B2 of the raw data B0 is further interrupted. Similarly, according to the previous three adjacent disks and the next three adjacent disks of the added disk number 11, it can be determined that the backup data B2 of the raw data B0 stored in the disk number 3 further needs to be cut into the added disk number 11. Therefore, it is ensured that the disk storing the raw data and the M disks respectively storing the backup data of the raw data are in a disk group formed of (M+1) disks logically connected to each other.

In the second case, when the first data is the check fragment data of the M pieces of fragmented data of the raw data and the M pieces of data corresponding to the first data are the M pieces of fragmented data of the raw data, the data backup processing method when one disk is added in the ring structure is as follows.

Specifically, after one disk is added in the ring structure, a group of (M+1) logically connected disks storing the M pieces of fragmented data and storing the check fragment data acquired from the M pieces of fragmented data may be interrupted. At this time, according to the data stored in the (M+1) disks adjacent to the newly added disk, the newly added data to be stored in the newly added disk is acquired. In consideration of the convenience of rebuilding the disk group, the newly added data is preferentially the data stored in disks at two ends of the disk group interrupted by the newly added disk (which may be one of the M pieces of fragmented data or the check fragment data). Next, the acquired newly added data is cut into the newly added disk. Certainly, other manners may also be adopted, for example, implementation through multiple times of data migration, as long as the (M+1) disks logically connected to each other in the ring structure respectively store the M pieces of fragmented data of the raw data and the check fragment data.

The data backup processing method of this embodiment may provide data redundancy for users among a random number of disks and may also add one disk in the ring structure, thereby achieving high flexibility and practicability.

By adopting the data backup processing method in Embodiment 2 and Embodiment 3, the number of disks required in the storage node may be flexibly changed according to the demands of the users, so the storage node has strong adaptability.

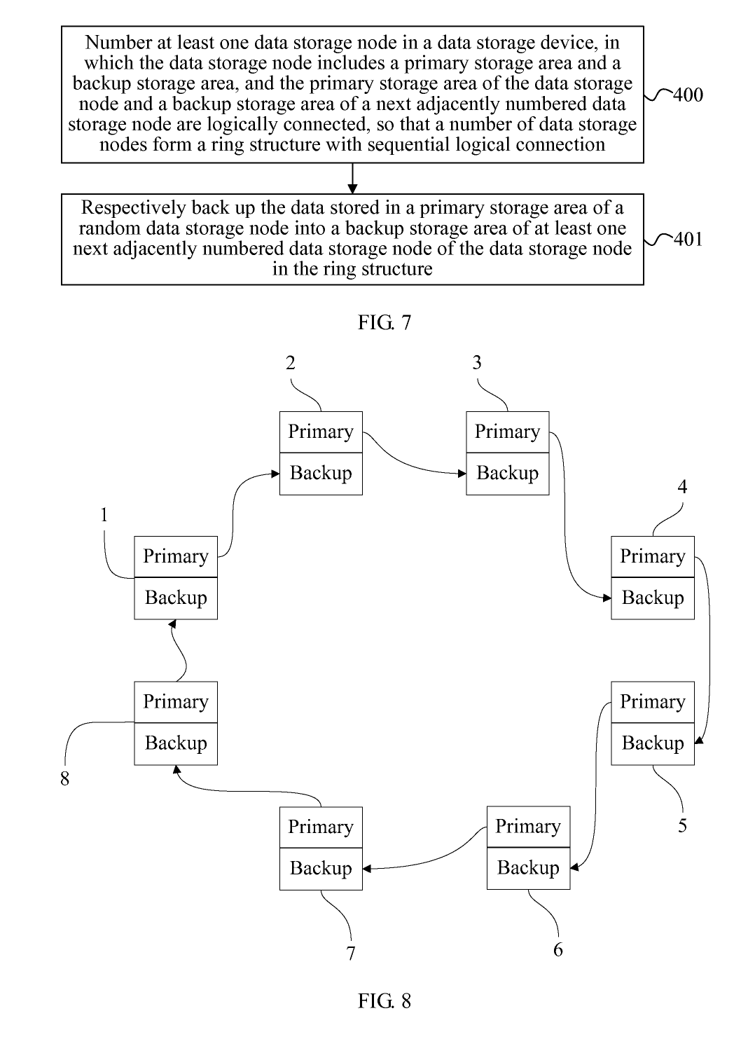

Embodiment 4 of the present invention provides a data backup processing method for performing redundancy backup for a number of data storage nodes in a data storage device to improve the security of the stored data. FIG. 7 is a flow chart of the data backup processing method according to Embodiment 4 of the present invention. Specifically, the data backup processing method includes the following steps.

Step 400: Number at least one data storage node in a data storage device. The data storage node includes a primary storage area and a backup storage area, and the primary storage area of the data storage node and a backup storage area of a next adjacently numbered data storage node are logically connected, so that a number of data storage nodes form a ring structure with sequential logical connection.

Step 401: Respectively back up the data stored in a primary storage area of a random data storage node into a backup storage area of at least one next adjacently numbered data storage node of the data storage node in the ring structure.

Specifically, at least one data storage node in a data storage device is numbered, for example, a data storage node 1, a data storage node 2, a data storage node 3, and the like. Each data storage node includes a primary storage area and a backup storage area. Next, the primary storage area of each data storage node is connected to a backup storage area of a next adjacent data storage node. The primary storage area of the corresponding last data storage node is connected to the backup storage area of the data storage node 1. Therefore, a ring structure having sequential logical connection is formed of a number of data storage nodes. The data stored in a primary storage area of any data storage node is backed up into a backup storage area of at least one next data storage node. Therefore, it is ensured that each piece of data stored in the primary storage area of the data storage node at least has one piece of backup data stored in a backup storage area of one next adjacent data storage node of the data storage node. Also, the backup data of the data may be respectively stored in the backup storage areas of two or more next adjacent data storage nodes of the data storage node.

It should be noted that, for the data storage node involved in this embodiment, the data backup processing methods in Embodiment 1 to Embodiment 3 are adopted in each data storage node, which can be referred to in Embodiment 1 to Embodiment 3, and are no longer described herein.

FIG. 8 is a fourth exemplary diagram of a data storage device according to an embodiment of the present invention. The exemplary diagram takes an example that the data storage device includes 8 storage nodes to illustrate the technical solution of Embodiment 4 of the present invention in detail. As shown in FIG. 8, primary storage areas and backup storage areas of adjacent storage nodes among the 8 storage nodes are logically connected in sequence to form a ring structure. The primary storage area in each storage node may include one or more pieces of stored data. For example, the storage node 1 includes stored data X and stored data Y. According to a predetermined backup path of the ring structure, if a user needs to store 1 backup of the data X and 3 backups of the stored data Y, the backup data of the stored data X is stored in a backup storage area of one next adjacent storage node (that is, the storage node 2) of the storage node 1 in the ring structure. The 3 pieces of backup data of the stored data Y are respectively stored in the backup storage areas of next three adjacent storage nodes (that is, the storage nodes 2, 3 and 4) of the storage node 1 in the ring structure.

In the data backup processing method of this embodiment, redundancy backup of data is performed through the backup path of the ring structure formed of a number of data storage nodes in the data storage device, so as to effectively guarantee the data security and reduce the risk of data loss.

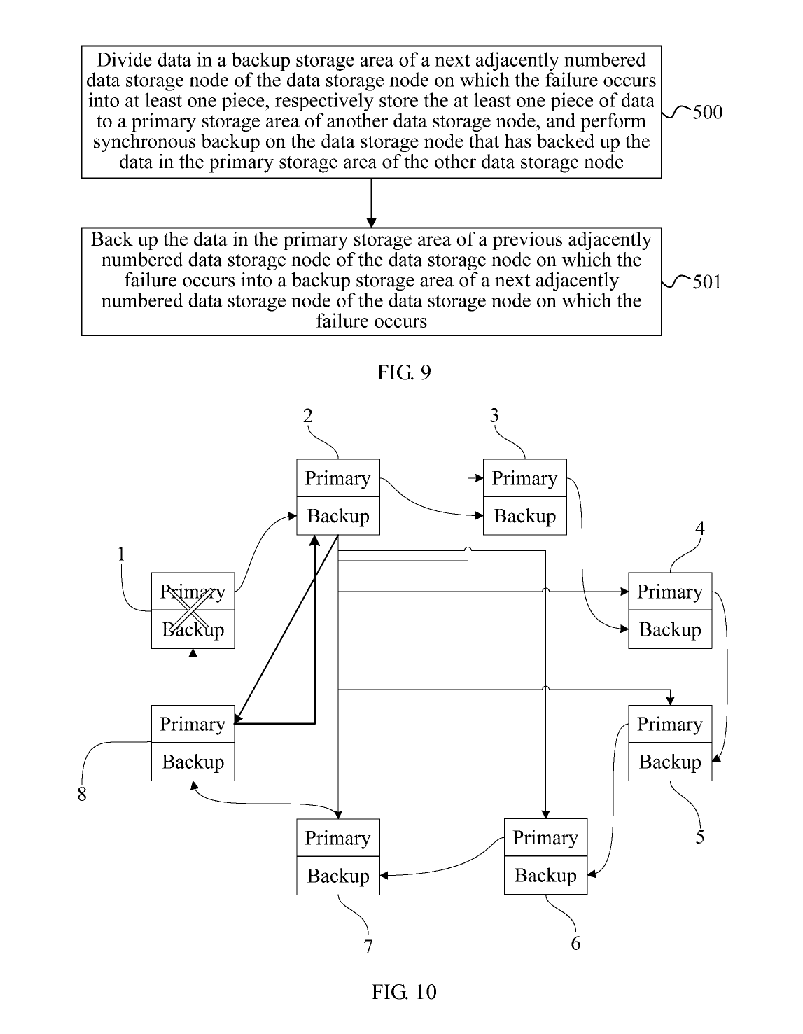

FIG. 9 is a partial flow chart of a data backup processing method according to Embodiment 5 of the present invention. In the ring structure in Embodiment 4, if a failure occurs on one storage node, the data backup processing method in Embodiment 5 of the present invention further includes steps shown in FIG. 9 on the basis of Embodiment 4 of the present invention, which are specifically as follows.

Step 500: Divide data in a backup storage area of a next adjacently numbered data storage node of the data storage node on which the failure occurs into at least one piece, respectively store the at least one piece of data to a primary storage area of another data storage node, and perform synchronous backup on the data storage node that has backed up the data in the primary storage area of the other data storage node.

That is to say, the backup data of the data in the primary storage area of the failed node is found through the data storage node adjacent to the failed data storage node, the backup data is divided into at least one piece and the at least one piece of data is stored in a primary storage area of another data storage node, and the data in the failed data storage node stored in the primary storage area of the other data storage node is synchronously backed up into a backup storage area of an adjacent data storage node.

Step 501: Back up the data in the primary storage area of a previous adjacently numbered data storage node of the data storage node on which the failure occurs into a backup storage area of a next adjacently numbered data storage node of the data storage node on which the failure occurs.

Specifically, FIG. 10 is a fifth exemplary diagram of a data storage device according to an embodiment of the present invention. The exemplary diagram is based on the fourth exemplary diagram of the data storage device according to the embodiment of the present invention shown in FIG. 9. A failure occurs on a storage node 1. As a next most adjacent storage node 2 of the storage node 1 stores all backup data of the storage node 1, at this time, according to capacity balance, the backup data in the storage node 2 is divided into at least one piece and the at least one piece of data is respectively stored in a primary storage area of another storage node, thereby ensuring the security of the data stored in the primary storage area of the storage node 1 on which the failure occurs. Next, synchronous backup is performed on the data storage node that has backed up the data in the primary storage area of the other data storage node. The number of pieces of data that the backup data in the storage node 2 is divided into is specifically determined according to the number of storage nodes included in the storage device and the capacity balance of the system. As the storage node 1 on which the failure occurs exits the ring structure, in the end the data in the primary storage area of the previous adjacently numbered data storage node 8 of the data storage node 1 on which the failure occurs needs to be backed up into a backup storage area of a next adjacently numbered data storage node of the data storage node on which the failure occurs, so as to rebuild a ring structure.

In the data backup processing method of this embodiment, when a failure occurs on one storage node, the lost data may be determined and the backup may be performed again, thereby reducing the risk of data loss and ensuring the security of the stored data.

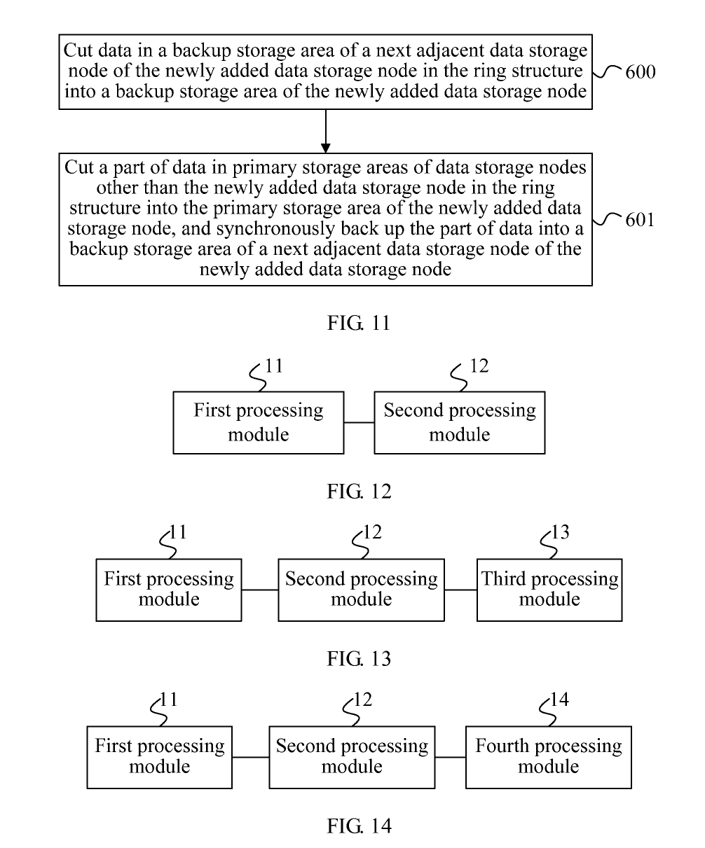

FIG. 11 is a partial flow chart of a data backup processing method according to Embodiment 6 of the present invention. When one storage node is added in the ring structure in Embodiment 4, the data backup processing method in Embodiment 6 of the present invention further includes steps shown in FIG. 11 on the basis of Embodiment 4 or Embodiment 5 of the present invention, which are specifically as follows.

Step 600: Cut data in a backup storage area of a next adjacent data storage node of the newly added data storage node in the ring structure into a backup storage area of the newly added data storage node.

Step 601: Cut a part of data in primary storage areas of data storage nodes other than the newly added data storage node in the ring structure into the primary storage area of the newly added data storage node, and synchronously back up the part of data into a backup storage area of a next adjacent data storage node of the newly added data storage node.

Specifically, after the data storage node is newly added, the data in the backup storage area of the next adjacent data storage node of the newly added data storage node is cut into the backup storage area of the newly added data storage node. Therefore, a backup relationship between the newly added data storage node and the previous storage node is ensured. Next, according to the system capacity balance, the part of data in the primary storage areas of the data storage nodes other than the newly added data storage node in the ring structure is cut into the primary storage area of the newly added data storage node. Next, all the data in the primary storage area of the newly added data storage node is backed up into the backup storage area of the next adjacent data storage node of the newly added data storage node. Therefore, a backup relationship between the newly added data storage node and the next storage node is ensured and a ring structure is rebuilt. The part of data in the primary storage areas of data storage nodes other than the newly added data storage node is cut into the newly added data storage node, and at the same time the corresponding synchronous backup further needs to be performed on the data stored in the data storage nodes other than the newly added data storage node.

In the data backup processing method of this embodiment, when a certain storage node on which a failure occurs exits a ring structure, one storage node may be further added in the ring structure, thereby achieving high flexibility.

By adopting the technical solutions in Embodiment 5 and Embodiment 6 of the present invention, on the basis of ensuring the security of user data in the storage node, the adaptability and flexibility of the storage node in the storage device may be further improved, so as to further satisfy the demands of users.

Persons of ordinary skill in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a Read-Only Memory (ROM), a Random Access Memory (RAM), a magnetic disk or an optical disk.

FIG. 12 is a structure diagram of a data storage node apparatus according to Embodiment 7 of the present invention. As shown in FIG. 12, the data storage node apparatus includes a first processing module 11 and a second processing module 12. The first processing module 11 is configured to number N disks within a data storage node, so that the N disks form a ring structure with sequential logical connection according to respective corresponding numbers thereof. The second processing module 12 is configured to respectively store first data and M pieces of data corresponding to the first data in (M+1) disks logically connected to each other in the ring structure, in which the (M+1) disks form one disk group, N and M are both positive integers, and N≧M+1. The first processing module 11 is configured to form a ring structure. The second processing module 12 is configured to implement data backup. The first data is raw data. The first data may include two cases. In the first case, the M pieces of data corresponding to the first data are respectively the backup data of the raw data. In the second case, the first data is the check fragment data of the M pieces of fragmented data of the raw data, so that the M pieces of data corresponding to the first data are the M pieces of fragmented data of the raw data.

In the first case of the first data, the data storage node apparatus adopts the corresponding data backup processing method in the first case of the first data in Embodiment 1 of the present invention. In the second case of the first data, the data storage node apparatus adopts the corresponding data backup processing method in the second case of the first data in Embodiment 1 of the present invention to realize data storage, which is no longer described herein.

The data storage node apparatus of this embodiment implements redundancy backup of stored data in logically connected disks in the ring structure and may provide data redundancy for users among a random number of disks, thereby guaranteeing the security of user data in the storage device. The data storage node apparatus of this embodiment may make a number of backups of the raw data, thereby effectively reducing the risk of loss of the stored data and improving the security of user data.

FIG. 13 is a structure diagram of a data storage node apparatus according to Embodiment 8 of the present invention. As shown in FIG. 13, the data storage node apparatus of this embodiment further includes a third processing module 13 on the basis of Embodiment 7 of the present invention. The third processing module 13 is configured to, when a failure occurs on one disk in the ring structure, according to data stored in (M+1) disks adjacent to the disk on which the failure occurs, acquire data stored in the disk on which the failure occurs, and back up the acquired data to a disk adjacent to a disk group where the disk on which the failure occurs belongs. The data storage node apparatus of this embodiment also has respectively two different cases: a first case and a second case of the first data. The data backup processing methods for the first case and the second case of the first data in Embodiment 2 of the present invention are respectively adopted to implement data storage, which are no longer described herein.

The data storage node apparatus of this embodiment may provide data redundancy for users among a random number of disks. When a failure occurs on one disk in the ring structure, the data stored in the disk on which the failure occurs may be determined and backed up into other disks again. When the data storage node apparatus of this embodiment is adopted, if a failure occurs on one disk, the effective operation of the storage system may still be ensured without changing the disk right away, thereby improving the security of user data and effectively reducing the risk of loss of the stored data, and achieving high practicability.

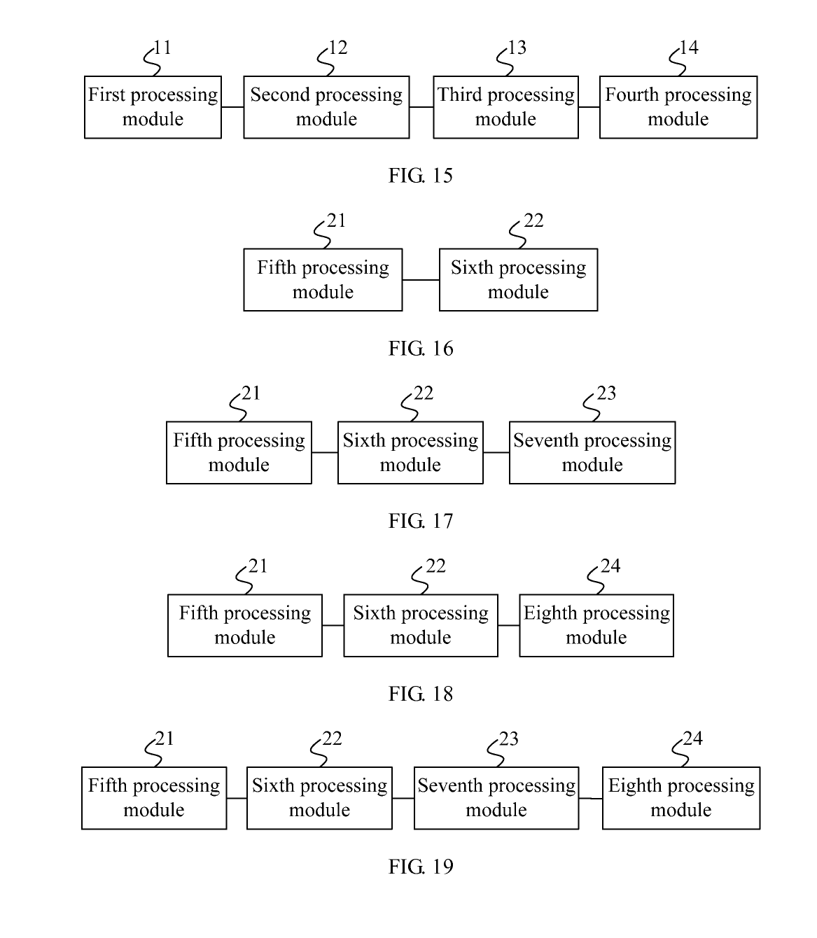

FIG. 14 is a structure diagram of a data storage node apparatus according to Embodiment 9 of the present invention. As shown in FIG. 14, the data storage node apparatus of this embodiment further includes a fourth processing module 14 on the basis of Embodiment 7 of the present invention. The fourth processing module 14 is configured to, when one disk is newly added in the ring structure, according to data stored in (M+1) disks adjacent to the newly added disk, acquire newly added data to be stored in the newly added disk, and cut data belonging to the newly added data in the (M+1) disks adjacent to the newly added disk into the newly added disk. It should be noted that, a fourth processing module 14 may also be added on the basis of Embodiment 8 of the present invention. At this time, the structure diagram of the corresponding data storage node apparatus is shown in FIG. 15. The data storage node apparatus of this embodiment also respectively has two different cases: a first case and a second case of the first data. The data backup processing methods for the first case and the second case of the first data in Embodiment 3 of the present invention are respectively adopted to implement data storage, which are no longer described herein.

For the data storage node apparatus provided in this embodiment, one disk may be flexibly added in the ring structure, so that the problem of quantitative requirement for the number of disks in the storage node in the prior art is solved, thereby achieving high flexibility and practicability.

The data storage node apparatuses in Embodiment 8 and Embodiment 9 may further flexibly change the number of disks required in the storage node apparatus according to the demands of users, such that the storage node achieves high adaptability.

FIG. 16 is a structure diagram of a data storage device according to Embodiment 10 of the present invention. As shown in FIG. 16, the data storage device includes a fifth processing module 21 and a sixth processing module 22. The fifth processing module 21 is configured to number at least one data storage node in a data storage device. The data storage node includes a primary storage area and a backup storage area, and the primary storage area of the data storage node and a backup storage area of a next adjacently numbered data storage node are logically connected, so that a number of data storage nodes form a ring structure with sequential logical connection. The sixth processing module 22 is configured to respectively back up the data stored in a primary storage area of a random data storage node into a backup storage area of at least one next adjacently numbered data storage node of the data storage node in the ring structure. The fifth processing module 21 is configured to form a ring structure. The sixth processing module 22 is configured to accomplish data backup.

The data storage node of the data storage device in this embodiment adopts any data storage node apparatus in Embodiment 7 to Embodiment 9, which can be specifically referred to in Embodiment 7 to Embodiment 9, and are no longer described herein.

The data storage device of this embodiment adopts the data backup processing method in Embodiment 4 of the present invention for data storage, which is no longer described herein.

For the data storage device provided in this embodiment, redundancy backup is performed on the data through the backup path of the ring structure formed of a number of data storage nodes in the data storage device, thereby effectively guaranteeing the data security and reducing the risk of data loss.

FIG. 17 is a structure diagram of a data storage device according to Embodiment 11 of the present invention. As shown in FIG. 17, the data storage device of this embodiment further includes a seventh processing module 23 on the basis of Embodiment 10 of the present invention. The seventh processing module 23 is configured to, when a failure occurs on one data storage node in the ring structure, divide data in a backup storage area of a next adjacently numbered data storage node of the data storage node on which the failure occurs into at least one piece, respectively store the at least one piece of data in a primary storage area of another data storage node, perform synchronous backup on the data storage node that has backed up the data in the primary storage area of the other data storage node (that is to say, find the backup data of the data in the primary storage area of the failed node through the next adjacently numbered data storage node of the failed data storage node, divide the backup data into at least one piece and store the at least one piece of data to a primary storage area of another data storage node, and synchronously back up the data in the failed data storage node stored in the primary storage area of the other data storage node), and synchronously back up the data in the failed data storage node stored in the primary storage area of the other data storage node into the backup storage area of the adjacent data storage node; and back up the data in the primary storage area of the previous adjacently numbered data storage node of the data storage node on which the failure occurs into a backup storage area of a next adjacently numbered data storage node of the data storage node on which the failure occurs. The data storage device of this embodiment adopts the data backup processing method in Embodiment 5 of the present invention to implement data storage, which is no longer described herein.

Through the data storage device provided in this embodiment, when a failure occurs on one storage node, the lost data may be determined and backed up again, thereby reducing the risk of data loss and ensuring the security of stored data.

FIG. 18 is a structure diagram of a data storage device according to Embodiment 12 of the present invention. As shown in FIG. 18, the data storage device of this embodiment further includes an eighth processing module 24 on the basis of Embodiment 10 of the present invention. The eighth processing module 24 is configured to, when one data storage node is newly added in the ring structure, cut data in a backup storage area of a next adjacent data storage node of the newly added data storage node in the ring structure into a backup storage area of the newly added data storage node; and cut a part of data in the primary storage area of data storage nodes other than the newly added data storage node in the ring structure into the primary storage area of the newly added data storage node, and synchronously back up the part of data into the backup storage area of the next adjacent data storage node of the newly added data storage node. It should be noted that, an eighth processing module 24 may also be added on the basis of Embodiment 11 of the present invention. At this time, the corresponding structure diagram of the data storage device is shown in FIG. 19. The data storage device of this embodiment adopts the data backup processing method in Embodiment 6 of the present invention to implement data storage, which is no longer described herein.

Through the data storage device provided in this embodiment, when a certain storage node on which a failure occurs exits the ring structure, one storage node may be added in the ring structure, thereby achieving high flexibility and practicability.

On the basis of ensuring the security of user data in the storage node, the data storage device in Embodiment 11 and Embodiment 12 may further improve the adaptability and flexibility of the storage node in the storage device, so as to further satisfy the demands of users.

Finally, it should be noted that the foregoing embodiments are merely provided for describing the technical solutions of the present invention, but not intended to limit the present invention. It should be understood by persons of ordinary skill in the art that although the present invention has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the present invention.

What is claimed is:

1. A data backup processing method, comprising:
numbering at least one data storage node in a data storage device, wherein the data storage node comprises a primary storage area and a backup storage area, and the primary storage area of the data storage node and a backup storage area of a next adjacently numbered data storage node are logically connected, so that a number of data storage nodes form a ring structure with sequential logical connection; and
respectively backing up data stored in a primary storage area of a random data storage node into a backup storage area of at least one next adjacently numbered data storage node of the data storage node in the ring structure.

2. The data backup processing method according to claim 1, wherein if a failure occurs on one data storage node in the ring structure, the method further comprises:
finding backup data of primary storage area data in the failed node through a next adjacently numbered data storage node of the failed data storage node, dividing the backup data into at least one piece, respectively storing the at least one piece of data in a primary storage area of another data storage node, and synchronously backing up the data in the failed data storage node stored in the primary storage area of the other data storage node; and
backing up data in a primary storage area of a previous adjacently numbered data storage node of the data storage node on which the failure occurs into a backup storage area of the next adjacently numbered data storage node of the data storage node on which the failure occurs.

3. The data backup processing method according to claim 1, wherein if one data storage node is newly added in the ring structure, the method further comprises:
cutting data in a backup storage area of a next adjacent data storage node of the newly added data storage node in the ring structure into a backup storage area of the newly added data storage node; and
cutting a part of data in primary storage areas of data storage nodes other than the newly added data storage node in the ring structure into a primary storage area of the newly added data storage node, and synchronously backing up the part of data into the backup storage area of the next adjacent data storage node of the newly added data storage node.

4. The data backup processing method according to claim 2, wherein if one data storage node is newly added in the ring structure, the method further comprises:
cutting data in a backup storage area of a next adjacent data storage node of the newly added data storage node in the ring structure into a backup storage area of the newly added data storage node; and
cutting a part of data in primary storage areas of data storage nodes other than the newly added data storage node in the ring structure into a primary storage area of the newly added data storage node, and synchronously backing up the part of data into the backup storage area of the next adjacent data storage node of the newly added data storage node.

5. A data backup processing method, comprising:
numbering N disks within a data storage node, so that the N disks form a ring structure with sequential logical connection according to respective corresponding numbers thereof; and
respectively storing first data and M pieces of data corresponding to the first data in (M+1) disks logically connected to each other in the ring structure, wherein the (M+1) disks form one disk group, N and M are both positive integers, and N≧M+1.

6. The data backup processing method according to claim 5, wherein
if the first data is raw data, the M pieces of data corresponding to the first data are respectively backup data of the raw data; or
if the first data is check fragment data of M pieces of fragmented data of the raw data, the M pieces of data corresponding to the first data are the M pieces of fragmented data of the raw data.

7. The data backup processing method according to claim 5, wherein if a failure occurs on one disk in the ring structure, the method further comprises:
acquiring data stored in the disk on which the failure occurs according to data stored in (M+1) disks adjacent to the disk on which the failure occurs; and
backing up the acquired data into a disk adjacent to a disk group where the disk on which the failure occurs belongs.

8. The data backup processing method according to claim 6, wherein if a failure occurs on one disk in the ring structure, the method further comprises:
acquiring data stored in the disk on which the failure occurs according to data stored in (M+1) disks adjacent to the disk on which the failure occurs; and
backing up the acquired data into a disk adjacent to a disk group where the disk on which the failure occurs belongs.

9. The data backup processing method according to claim 5, wherein
if one disk is newly added in the ring structure, the method further comprises:
acquiring newly added data to be stored in the newly added disk according to data stored in (M+1) disks adjacent to the newly added disk; and
cutting data belonging to the newly added data in the (M+1) disks adjacent to the newly added disk into the newly added disk.

10. The data backup processing method according to claim 6, wherein
if one disk is newly added in the ring structure, the method further comprises:
acquiring newly added data to be stored in the newly added disk according to data stored in (M+1) disks adjacent to the newly added disk; and
cutting data belonging to the newly added data in the (M+1) disks adjacent to the newly added disk into the newly added disk.

11. A data storage node apparatus, comprising:
a first processing module, configured to number N disks within a data storage node, so that the N disks form a ring structure with sequential logical connection according to respective corresponding numbers thereof; and
a second processing module, configured to respectively store first data and M pieces of data corresponding to the first data in (M+1) disks logically connected to each other in the ring structure, wherein the (M+1) disks form one disk group, N and M are both positive integers, and N≧M+1.

12. The data storage node apparatus according to claim 11, further comprising:
a third processing module, configured to, when a failure occurs on one disk in the ring structure, according to data stored in (M+1) disks adjacent to the disk on which the failure occurs, acquire data stored in the disk on which the failure occurs; and back up the acquired data into a disk adjacent to a disk group where the disk on which the failure occurs belongs.

13. The data storage node apparatus according to claim 11, further comprising:
a fourth processing module, configured to, when one disk is newly added in the ring structure, according to data stored in (M+1) disks adjacent to the newly added disk, acquire newly added data to be stored in the newly added disk; and cut data belonging to the newly added data in the (M+1) disks adjacent to the newly added disk into the newly added disk.

14. The data storage node apparatus according to claim 12, further comprising:
a fourth processing module, configured to, when one disk is newly added in the ring structure, according to data stored in (M+1) disks adjacent to the newly added disk, acquire newly added data to be stored in the newly added disk; and cut data belonging to the newly added data in the (M+1) disks adjacent to the newly added disk into the newly added disk.

15. A data storage device, comprising a data storage node apparatus according to claim 11, and further comprising:
a fifth processing module, configured to number at least one data storage node apparatus in a data storage device, wherein the data storage node comprises a primary storage area and a backup storage area, and the primary storage area of the data storage node and a backup storage area of a next adjacently numbered data storage node are logically connected, so that a number of data storage nodes form a ring structure with sequential logical connection; and
a sixth processing module, configured to respectively back up data stored in a primary storage area of a random data storage node into a backup storage area of at least one next adjacently numbered data storage node of the data storage node in the ring structure.

16. The data storage device according to claim 15, further comprising:
a seventh processing module, configured to, when a failure occurs on one data storage node in the ring structure, divide data in a backup storage area of a next adjacently numbered data storage node of the data storage node on which the failure occurs into at least one piece, respectively store the at least one piece of data to a primary storage area of another data storage node, and perform synchronous backup on a data storage node that has backed up data in the primary storage area of the other data storage node; and back up data in a primary storage area of a previous adjacently numbered data storage node of the data storage node on which the failure occurs into a backup storage area of a next adjacently numbered data storage node of the data storage node on which the failure occurs.

17. The data storage device according to claim 15, further comprising:
an eighth processing module, configured to, when one data storage node is newly added in the ring structure, cut data in a backup storage area of a next adjacent data storage node of the newly added data storage node in the ring structure into a backup storage area of the newly added data storage node; and cut a part of data in primary storage areas of data storage nodes other than the newly added data storage node in the ring structure into a primary storage area of the newly added data storage node, and synchronously back up the part of data into the backup storage area of the next adjacent data storage node of the newly added data storage node.

18. The data storage device according to claim 16, further comprising:
an eighth processing module, configured to, when one data storage node is newly added in the ring structure, cut data in a backup storage area of a next adjacent data storage node of the newly added data storage node in the ring structure into a backup storage area of the newly added data storage node; and cut a part of data in primary storage areas of data storage nodes other than the newly added data storage node in the ring structure into a primary storage area of the newly added data storage node, and synchronously back up the part of data into the backup storage area of the next adjacent data storage node of the newly added data storage node.
